(19) United States
(12) Patent Application Publication
(10) Pub. No.: US 2024/0181472 A1
(43) Pub. Date: Jun. 6, 2024

(54) SHOWERHEAD WITH HYPERBOLOID SPRAYS

(71) Applicant: ETL, LLC, Sparks, NV (US)

(72) Inventor: David Hofman, Reno, NV (US)

(21) Appl. No.: 18/073,373

(22) Filed: Dec. 1, 2022

(51) Int. Cl. B05B 1/06; B05B 1/18; B05B 1/34

(52) U.S. Cl. CPC B05B 1/06; B05B 1/185; B05B 1/3405

(57) ABSTRACT

A showerhead assembly is provided which includes a showerhead having a faceplate with an inner ring of nozzles and an outer ring of nozzles. Each nozzle of the outer ring points radially inward and with the same angle in a first direction tangential to the outer ring. Further, each nozzle of the inner ring points radially inward and with the same angle in a second direction tangential to the outer ring. Preferably, the outer ring nozzles point radially inward the same angle as the inner ring nozzles, but the outer ring nozzles point tangentially in the opposite directions as the inner ring. The nozzles are configured to emit non-intersecting narrow streams of water. The second spray is concentrically nested within the first spray and, collectively, the sprays produce a hyperboloid shape having a woven or lattice-like pattern.

### BACKGROUND OF THE INVENTION

The present invention relates to showerheads. More particularly, this invention relates to showerheads having a first nozzle set and a second nozzle set, wherein each nozzle set produces a hyperboloid spray pattern.

Spray heads are commercially available in numerous designs and configurations for use in showers, faucets, spas, sprinklers and other personal and industrial systems. Spray heads may be categorized as being either stationary or oscillating and may have fixed or adjustable openings. Stationary spray heads with fixed jets are the simplest constructions consisting essentially of a central conduit connected to one or more spray jets directed to produce a constant pattern. The stationary spray showerheads cause water to flow through the construction to contact essentially the same points on a user's body in a repetitive fashion. Multi-function spray heads are able to deliver water in different spray patterns such as fine spray, a coarse spray, a pulsating spray, or even a flood pattern producing a high fluid flow but decreased velocity.

Of course, many other spray patterns may also be provided. For example, Chinese Patent No. CN205949103 discloses a showerhead producing a crisscross spray pattern having a hyperboloid shape. In this construction, however, each nozzle is offset relative to its neighboring nozzles along a circular array, and each nozzle sprays water in a different direction from each adjacent nozzle. Similarly, U.S. Pat. No. 10,987,680 discloses a showerhead producing a first spray pattern and a second spray pattern that are hyperboloid in shape. In the embodiments disclosed therein, however, the hyperboloid shape of the second spray pattern either differs from the hyperboloid shape of the first spray pattern, or produces a quasi-focus area (i.e., a part of the spray pattern comprising the smallest cross-sectional area) that is offset in length by the quasi-focus area of the first spray pattern.

Though these references both disclose a showerhead providing a spray with a hyperboloid shape, none of the references describe a showerhead producing multiple sprays, wherein each spray comprises the same hyperboloid of revolution shape and equal length quasi-focus areas. Moreover, none of the references describe a showerhead having two sets of nozzles configured in circular arrays, wherein one nozzle set is concentrically disposed in the other nozzle set, and wherein the nozzles in each nozzle set spray water at a same angle and radially inward direction as their neighboring nozzles, but in an opposite tangential direction as the nozzles of the other nozzle set so as to produce an overall hyperboloid shaped spray providing concentrated coverage and increased water pressure to a directed area. In the foregoing constructions, water pressure experienced by the bather in a particular area is limited due to the spray trajectories and/or nozzle configuration.

Thus, it would be advantageous to provide a showerhead assembly having multiple nozzle sets, wherein the sprays produced by each nozzle set do not intersect but provide two sprays of water directed to substantially the same points on a user's body in a repetitive fashion so as to provide a dispersion of spray in a concentrated fashion. In this manner, the desired showerhead assembly could improve the spray pattern's overall feel and user experience, while also saving water.

### SUMMARY OF THE INVENTION

The present invention addresses the aforementioned disadvantages by providing an improved showerhead assembly which includes a plurality of nozzle sets that each produce a spray pattern having a hyperboloid shape. Specifically, the showerhead assembly includes a showerhead having a housing with a faceplate. More specifically, the faceplate comprises a set of inner nozzles and a set of outer nozzles. The set of outer nozzles are configured in a circular array to form outer ring and the set of inner nozzles are configured in a circular array to form an inner ring. Further, the inner ring is concentrically disposed within the outer ring. In preferred embodiments, the outer nozzles are each pointing radially inward and in a first direction tangential to the outer ring. Additionally, the inner nozzles are each pointing radially inward and in a second direction tangential to the inner ring. Specifically, the first direction and second direction are tangentially opposite of one another. More specifically, the inner nozzles and outer nozzles are pointing at the same angle but in opposing directions from one another. In this manner, the spray trajectories produced by each set of nozzles are directed to substantially the same area in a non-intersecting manner. As such, water pressure is increased and spray feel is improved.

Further, the preferred showerhead can be relatively traditional in construction including a showerhead housing connected to a water source. Preferably, a female threaded inlet is threadably engaged to a male threaded pipe providing the source of water. More preferably, the showerhead housing includes a primary conduit configured to be in fluid connection with the female threaded inlet so as to receive water therefrom and transport water to the set of inner nozzles and set of outer nozzles for dispersion therefrom.

In the preferred embodiment, the set of inner nozzles comprises the same number of nozzles as the set of outer nozzles. Moreover, each outer nozzle is equidistant from its neighboring outer nozzles along the outer ring. Similarly, each inner nozzle is equidistant from inner nozzles adjacent thereto along the inner ring. Preferably, the inner nozzles and outer nozzles are positioned along their respective circular arrays so as to be in parallel alignment with one another. For example, an outer nozzle is in parallel alignment with an inner nozzle. In this regard, each outer nozzle lies along a same angular axis from the rings' center as an inner nozzle. Preferably, each outer nozzle is configured to disperse water in a stream sufficiently narrow so as to not collide substantially or at all with other streams of water. In this manner, the set of outer nozzles produce a spray having a hyperboloid shape. Similarly, each inner nozzle is configured to disperse water in a stream sufficiently narrow so as to not collide substantially or at all with other streams of water. As such, the set of inner nozzles produce a spray having a hyperboloid shape.

More preferably, the set of outer nozzles produce a first spray pattern having a smallest cross-sectional area (hyperbolic focal point) and the set of inner nozzles produces a second spray pattern having a smallest cross-sectional area, wherein the smallest cross-sectional area of each spray pattern is an equal distance away from the faceplate. Further, the first spray pattern and the second spray pattern are concentric to one another. Preferably, the second spray pattern is nested within the first spray pattern. More preferably, the first spray pattern and second spray pattern produce an overall spray having a hyperboloid spray with a lattice-like pattern, although the two spray patterns' streams do not intersect.

Thus, it is an object of the present invention to provide a showerhead assembly having a plurality of hyperboloid spray patterns having non-intersection streams of water so as to deliver more powerful spray trajectories that do not lose energy or velocity due to spray interference. In this way, the plurality of sprays produce the overall appeal of a lattice-like hyperboloid spray without energy loss from stream convergence.

It is an additional object of the present invention to provide a showerhead assembly with a plurality of nozzle sets configured to spray narrow streams of water producing hyperboloid spray patterns directed from opposite directions but to substantially the same area in the showerhead. In this way, the showerhead assembly provides a dispersed yet concentrated spray having an improved look and feel.

Other features and advantages of the present invention will be appreciated by those skilled in the art upon reading the detailed description which follows with reference to the drawings.

### BRIEF DESCRIPTION OF THE DRAWINGS

These and other, further and more specific objects and advantages of the invention will be apparent to those skilled in the art form the following detailed description thereof, taken in conjunction with the Drawings, in which:

FIG. 1 is a front perspective view depicting an exemplar embodiment of the showerhead assembly having two nozzle sets, wherein the set of outer nozzles are configured in a circular array along an outer ring and the set of inner nozzles are configured in a circular array along an inner ring.

FIG. 2 is a right perspective view depicting an exemplar embodiment of the showerhead assembly having two sets of nozzles and ancillary nozzles, wherein each inner nozzle is aligned with and parallel to an outer nozzle, and wherein each nozzle set comprises the same number of nozzles.

FIG. 3A is right perspective view of the showerhead assembly illustrated in FIG. 2, depicting the set of outer nozzles spraying water in a direction radially inward of and tangential to the outer ring so as to produce a hyperboloid spray pattern

FIG. 3B is a side view of the hyperboloid spray pattern produced by the set of outer nozzles of the showerhead assembly illustrated in FIG. 2.

FIG. 4A is right perspective view of the showerhead assembly illustrated in FIG. 2, depicting the set of inner nozzles spraying water in a direction radially inward of and tangential to the inner ring so as to produce a hyperboloid spray pattern.

FIG. 4B is a side view of the hyperboloid spray pattern produced by the set of inner nozzles of the showerhead assembly illustrated in FIG. 2.

FIG. 5A is a side cutaway cross-sectional view from the central point of the showerhead assembly illustrated in FIG. 2, illustrating the outer nozzles pointing in a radially inward direction relative to the circular array of the outer ring.

FIG. 5B is a side partial cutaway view of the showerhead assembly illustrated in FIG. 2, illustrating the water flow therethrough.

FIG. 6A is right perspective view of the showerhead assembly illustrated in FIG. 2, depicting the set of outer nozzles spraying water in a direction radially inward of and tangential to the outer ring, and the set of inner nozzles spraying water in a direction radially inward of and tangential to the outer ring, but opposite the direction of the water spraying from the outer nozzle set.

FIG. 6B is a side view of the hyperboloid spray patterns produced by the set of outer nozzles and set of inner nozzles, depicting both spray patterns having a smallest cross-sectional area equidistant from the showerhead faceplate.

FIG. 7 is a side view of the showerhead assembly illustrated in FIG. 2, depicting the outer nozzles pointing at an angle tangential to the outer ring on the faceplate.

FIG. 8 is a top view of the showerhead assembly illustrated in FIG. 2, depicting the outer nozzles pointing in a radially inward direction relative to the outer ring on the faceplate.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

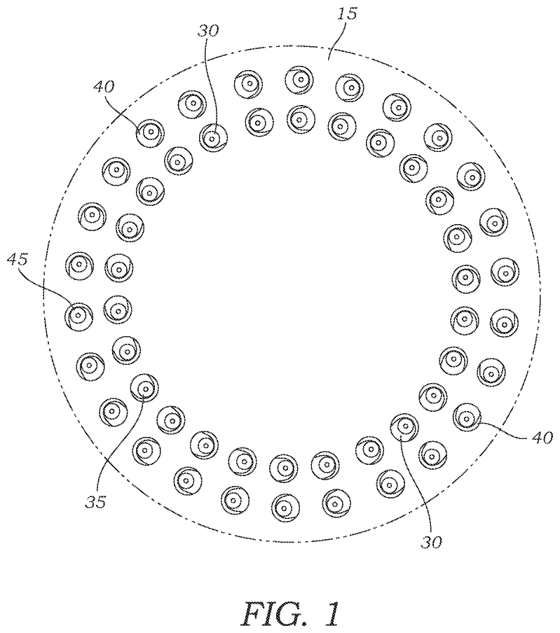

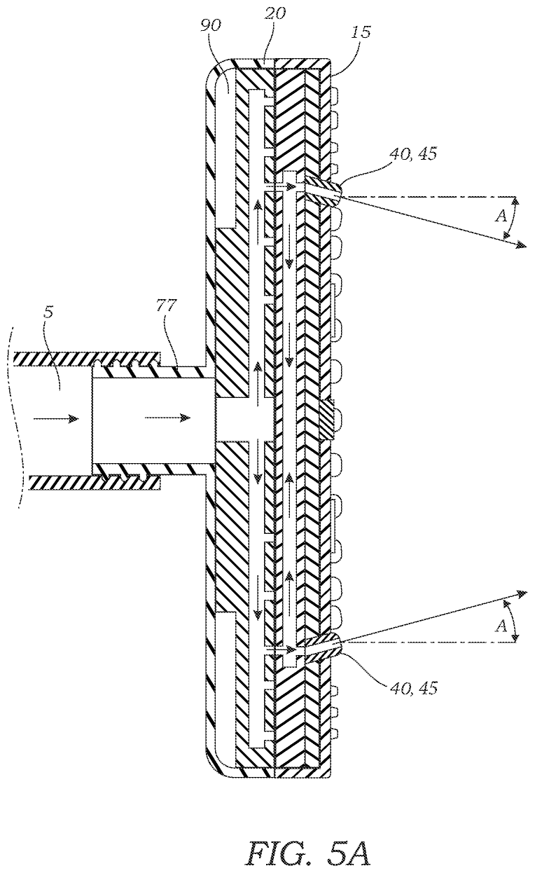

With reference to FIGS. 1-8, the water spraying assembly of the present invention is illustrated as a showerhead assembly 1 having a showerhead 90 with a housing 20 which includes a faceplate 15 with a set of inner nozzles 30 and a set of outer nozzles 40 projecting therefrom. Like traditional constructions, the preferred showerhead housing 20 is connected to a water source. Preferably, this showerhead housing 20 includes a longitudinally extending tubular primary conduit 5 (best shown in FIGS. 5A and 5B) in fluid connection with a female threaded inlet that threadably engages to a male threaded pipe providing the source of water. In this manner, and as best shown in FIG. 5B, the primary conduit 5 can provide water to the set of inner nozzles 30 and the set of outer nozzles 40 so as to allow such water to disperse therefrom.

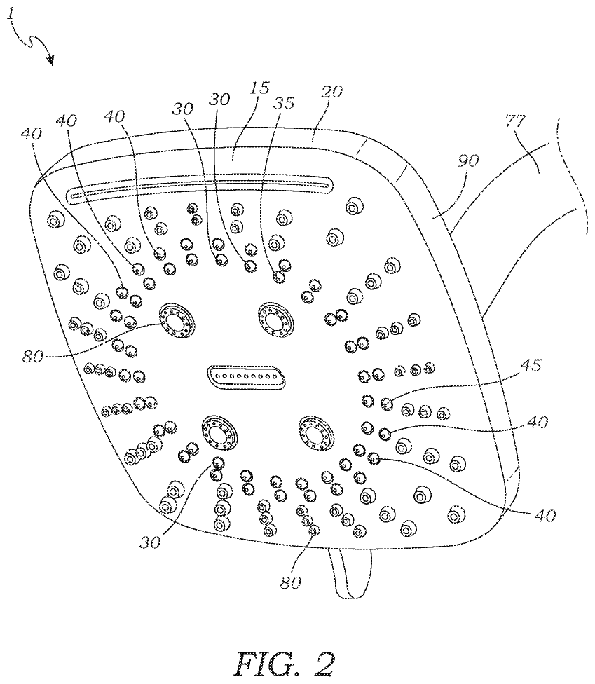

In some preferred embodiments, and as illustrated in FIGS. 2, 3A, 4A, and 6, the showerhead 90 is constructed as a stationary showerhead 90. In these embodiments, the stationary showerhead 90 can be connected to the water source by a neck portion 77. As understood by those skilled in the art, water is capable of flowing through a channel within the neck portion, which is fluid connection with the primary conduit 5, so as to transport water to the two sets of nozzles 30, 40 on the faceplate 15 of the showerhead housing 20 (e.g., FIG. 5B illustrating the water flowing from the primary conduit and ultimately spraying out of the outer nozzle 40).

In other preferred embodiments (though not illustrated), the showerhead 90 is constructed as a handheld showerhead. In these embodiments, the handheld showerhead 90 includes an elongate hollow handle extending longitudinally so as to define a longitudinal axis. Preferably, in these embodiments, the faceplate 15 on the handheld showerhead 90 is configured to face an angle between 45° and 90° relative to the elongate hollow handle's longitudinal axis. Though not illustrated, those of skill in the art will recognize that like traditional handheld showerheads, the elongate hollow handle can further include a proximal end threadably affixed to a flexible hose so as to allow the user to control and manipulate the orientation of the showerhead 90. As further understood by those skilled in the art, in these embodiments, water is capable of flowing through a channel (not shown) within a center of the elongate hollow handle, which is in fluid connection with the primary conduit 5, so as to transport water to the two sets of nozzles 30, 40 configured to spray water therefrom.

Preferably, the faceplate 15 comprises a set of inner nozzles 30 and a set of outer nozzles 40. More preferably, and as best shown in FIG. 1, the outer nozzles 40 are configured in a circular array to form an outer ring 45 on the faceplate 15. Further, the inner nozzles 30 are configured in a circular array to form an inner ring 35 on the faceplate 15. In preferred embodiments, the inner ring 35 is positioned so as to be concentrically disposed within the outer ring 45. In this regard, the outer ring 45 has a radius that is greater than the radius of the inner ring 35. Specifically, each inner nozzle 30 is spaced an equal radial distance from the central point of the showerhead faceplate 15. Additionally, each outer nozzle 40 is spaced an equal radial distance from a central point of the showerhead faceplate 15. Preferably, the nozzles 30 of the inner ring 35 are equal in number as the nozzles 40 of the outer ring. Also preferably, the inner nozzles 30 of the inner ring 35 are spaced circumferentially equidistant from one another, and the outer nozzles 40 of the outer ring 45 are spaced circumferentially equidistant from one another. More preferably, both the set of inner nozzles 30 and set of outer nozzles 40 are positioned along their respective rings 35, 45 so as to lie along the same central radius relative to the faceplate 15. Since the inner nozzles 30 are equal in number as the outer nozzles 40, adjacent inner nozzles 30 of the inner ring 35 and adjacent nozzles 40 of the outer ring 45 have the same central angle.

In some embodiments, and as shown in FIGS. 1, 2, 3A, 4A, and 6, the set of outer nozzles 40 and set of inner nozzles 30 each comprise the same number of nozzles. In some preferred exemplar embodiments (not shown), there are 14 inner nozzles 30 and 14 outer nozzles 40, for a total of 28 nozzles between both set of nozzles 30, 40, collectively. Those of skill in the art will recognize that fewer or additional nozzles can be utilized per each set of nozzles 30, 40. Further, additional ancillary nozzles 80 can be provided on the faceplate 15, as depicted in FIGS. 2, 3A, 4A, and 6. Various channel, conduit, showerhead face, and nozzle constructions providing the capabilities described herein can be determined by those skilled in the art.

Preferably, and as best illustrated in FIGS. 1, 2, 3A, 4A, and 6, each inner nozzle 30 is concentrically aligned with an outer nozzle 40, wherein each outer nozzle 40 is radially outward of and directly adjacent to its concentrically aligned inner nozzle 30. More preferably, the set of inner nozzles 30 and the set of outer nozzles 40 are positioned along the inner ring 35 and outer ring 45, respectively, such that each inner nozzle 30 is in parallel alignment with an outer nozzle 40. In this manner, each inner nozzle 30 lies along a same longitudinal axis as an outer nozzle 40.

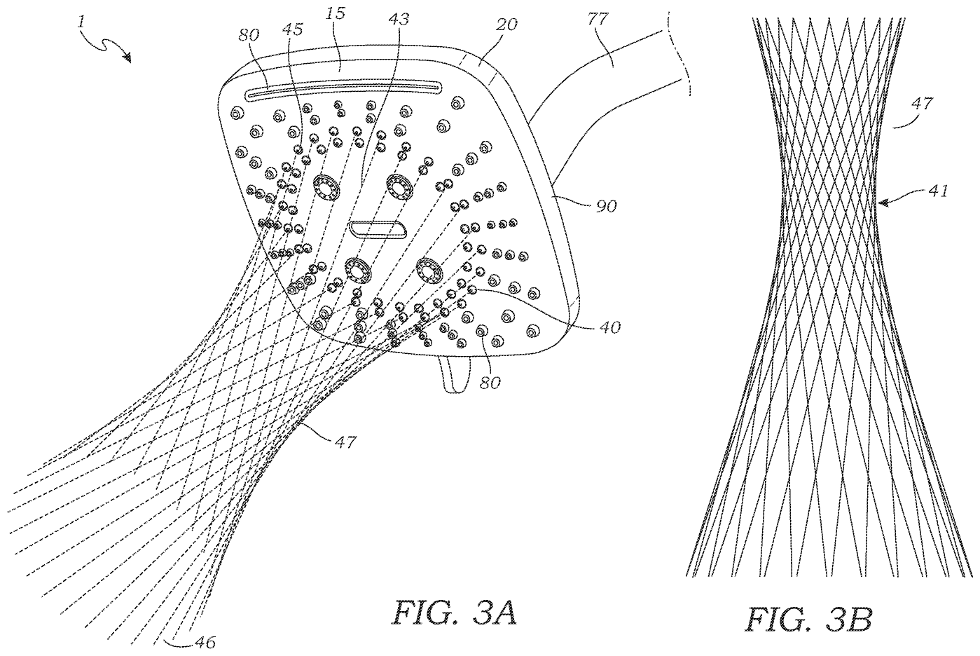

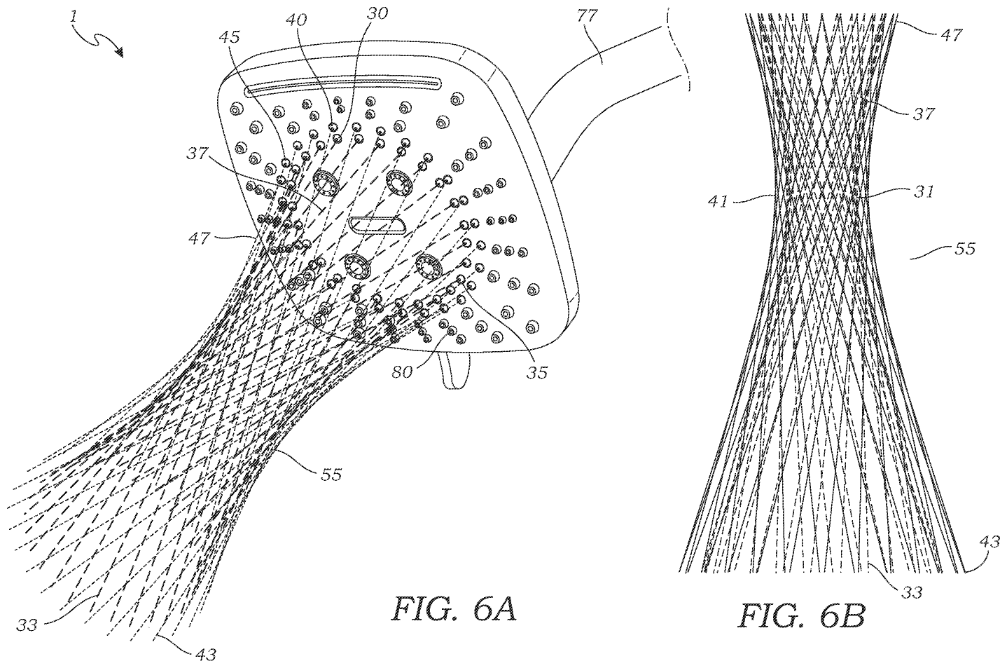

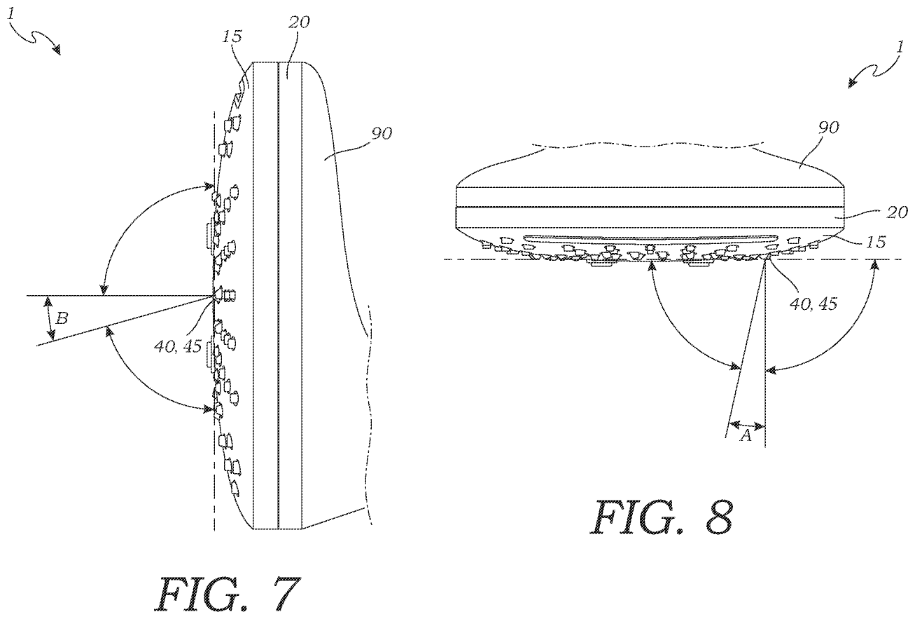

As best illustrated in FIGS. 3A, each outer nozzle 40 is pointing radially inward of the outer ring 45. Further, each outer nozzle 40 is rotated at an angle in a first direction tangential to the outer ring 45. Preferably, each outer nozzle 40 is pointing at the same angle radially inward of the outer ring 45. Further, each outer nozzle 40 is pointing radially inward of the outer ring 45 at an angle between 1-45 degrees (outer nozzle 40 pointing radially inward of outer ring 45 is best shown by “A” in FIGS. 5A and 8). In some preferred embodiments, each outer nozzle 40 is pointing radially inward of the outer ring 45 at about a 12-12.5 degree angle. Also in some preferred embodiments, each outer nozzle 40 is rotated at the same angle in the first direction tangential to the outer ring 45 (FIG. 3A). Preferably, each outer nozzle 40 is rotated the same 1-45 degrees in the first direction tangential to the outer ring 45 (tangential angle of outer nozzle 40 relative to the outer ring 45 is best shown by “B” in FIG. 7). More preferably, each outer nozzle 40 is rotated about 15-15.5 degrees in the first direction tangential to the outer ring 45. In preferred embodiments, each outer nozzle 40 sprays water at a trajectory having an overall angle relative to the faceplate 15, or an overall tilt, of about 19.5 degrees from perpendicular to the showerhead's face.

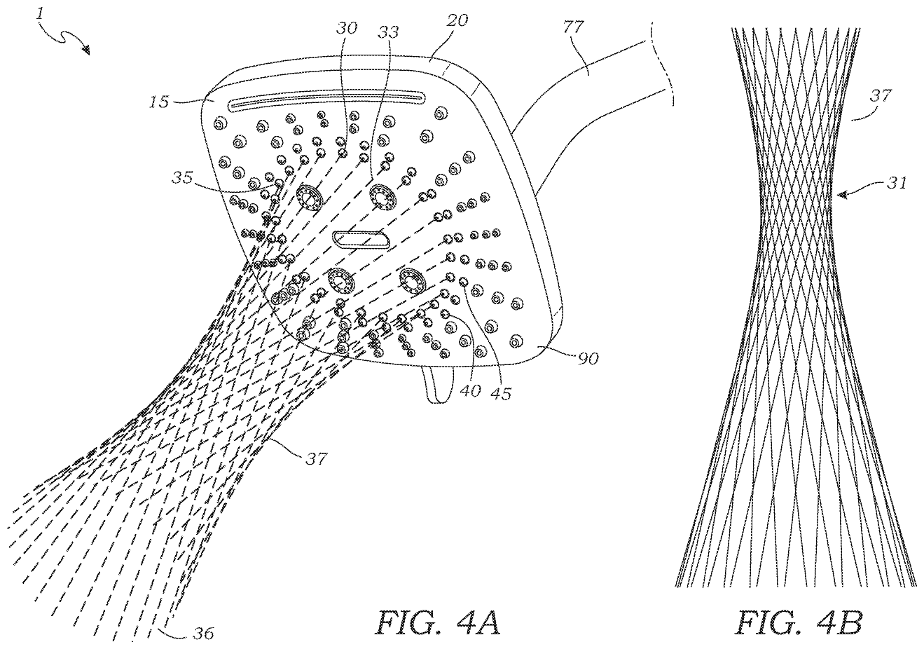

In like manner, and as best depicted in FIG. 4A, each inner nozzle 30 is pointing radially inward of the inner ring 35. Further, in preferred embodiments, each inner nozzle 30 is rotated at an angle in a second direction tangential to the inner ring 35. Preferably, each inner nozzle 30 is pointing radially inward of the inner ring 35 at the same angle. More preferably, each inner nozzle 30 is pointing radially inward of the inner ring 35 at about a 12-12.5 degree angle. Further, each inner nozzle 30 is rotated at the same angle in the second direction tangential to the inner ring 35. In preferred embodiments, each inner nozzle 30 is rotated at the same 1-45 degrees in the second direction tangential to the inner ring 35. Specifically, it is preferred that each inner nozzle 30 is rotated about 15-15.5 degrees in the second direction tangential to the inner ring 35. In preferred embodiments, each inner nozzle 30 sprays water at a trajectory having an overall tilt of about 19.5 degrees from perpendicular to the showerhead face.

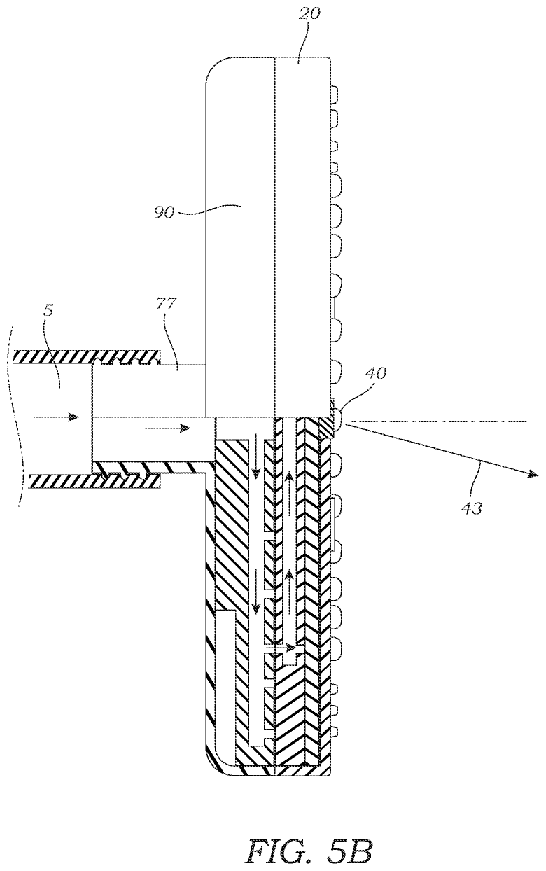

In preferred embodiments, and as best shown in FIG. 6A, the second direction of the inner nozzles 30 is opposite of the first direction of the outer nozzles 40. For example, and still with reference to FIG. 6A, if the inner nozzles 30 are each pointing in the same counterclockwise direction, then the outer nozzles 40 are each pointing in the same clockwise direction. Conversely, in some embodiments, if the outer nozzles 40 are each pointing in the same clockwise direction, then the inner nozzles 30 are each pointing in the same counterclockwise direction. Further, in some preferred embodiments, the inner nozzles 30 and outer nozzles 40 can be rotated tangential to their respective rings at the same angle as one another, but be pointing in opposite directions (e.g., FIG. 1 illustrating the set of inner nozzles 30 pointing in opposite direction as the set of outer nozzles 40). For example, each outer nozzle 40 can be rotated about 15-15.5 degrees in the first direction tangential to the outer ring 45, and each inner nozzle 30 can be rotated about 15-15.5 degrees in the second direction tangential to the inner ring 35, wherein the second direction is opposite of the first direction.

Further, in some preferred embodiments, the outer nozzles 40 can be pointing radially inward of the outer ring 45 at a same angle as the inner nozzles 30 are pointing radially inward of the inner ring 35. For example, each outer nozzle 40 can be pointing radially inward of the outer ring 45 at about a 12-12.5 degree angle, and each inner nozzle 30 can pointing radially inward of the inner ring 35 at about a 12-12.5 degree angle.

Preferably, the set of inner nozzles 30 and the set of outer nozzles 40 each produce spray trajectories having the same overall tilt angle relative to their respective rings. In some exemplar embodiments, the set of outer nozzles 40 spray water at a trajectory having an overall tilt of about 19.5 degrees, and the set of inner nozzles 30 spray water at a trajectory having an overall tilt of about 19.5 degrees. Though the overall tilt angle of the spray trajectories may be the same, the direction of the spray trajectories are opposite of one another due to the directions the nozzles 30, 40 are tangentially rotated relative to their respective rings 35, 45.

Moreover, in preferred embodiments, each outer nozzle 40 is configured to disperse water in a narrow stream, wherein the streams are each sufficiently narrow so as to not intersect substantially or at all with one another. As such, and as shown in FIG. 3B, the set of outer nozzles 40 produce a first set of narrow streams 43 having a first spray pattern 47 with a hyperboloid of revolution shape. In a similar fashion, and as illustrated in FIG. 4B, each inner nozzle 30 is configured to disperse water in a narrow stream, wherein the streams are each sufficiently narrow so as to not intersect substantially or at all with one another. In this regard, the set of inner nozzles 30 produce a second set of narrow streams 33 having a second spray pattern 37 with a hyperboloid of revolution shape.

In some embodiments, and with reference to FIG. 6B, the set of inner nozzles 30 and set of outer nozzles 40 are configured to simultaneously spray water such that the first spray pattern 47 and second spray pattern 37 emit in a contemporaneous fashion. In preferred embodiments, a smallest cross-sectional area 41 (hyperbolic focal point) of the first spray pattern 47 and a smallest cross-sectional area 31 (hyperbolic focal point) of the second spray pattern 37 are an equal distance away from the faceplate 15, as depicted in FIG. 6B. In this manner, the smallest cross-sectional areas 31, 41 of both spray patterns 37, 47 lie along the same plane.

As illustrated in FIG. 6B, in some preferred embodiments, the second spray pattern 37 is nested within the first spray pattern 47. Preferably, the first spray pattern 47 and the second spray pattern 37 are concentric and do not intersect or collide. Further, the first spray pattern 47 is configured to form a first spray matrix 46 (best shown in FIG. 3A), or a first cross-sectional spray shape, and the second spray pattern 37 is configured to form a second spray matrix 36 (best shown in FIG. 4A), or second cross-sectional spray shape, wherein the first spray matrix 46 and second spray matrix 36 form the same shape (e.g., circular). Also preferably, because the inner nozzles 30 and outer nozzles 40 are all pointing at the same angle but in opposite directions from one another, their respective stream trajectories spray in opposing directions (best illustrated in FIG. 6A). Thus, in some embodiments, although the first spray pattern 47 and second spray pattern 37 do not intersect, the opposing spray pattern trajectories, collectively, produce an overall impression of intersecting streams, wherein the overall spray 55 is a hyperboloid spray having a woven or lattice-like pattern. As such, one such advantage of this showerhead assembly 1 is the aesthetic appeal of the overall spray 55 produced. Further, the showerhead assembly 1 also provides the benefit of a stronger more powerful rinse by not having the streams of water collide with one another. Specifically, streams of water produced by the outer nozzles 40 and inner nozzles 30 will not lose energy or water pressure due to impact or collision with other streams of water.

In this manner, and further because each outer nozzle 40 is concentrically aligned with an inner nozzle 30, the overall spray 55 provides for greater and more powerful dispersion of water. For example, in some embodiments, each inner nozzle 30 is directly adjacent to and one nozzle to the right (or left) of an outer nozzle 40 which is configured to spray water to substantially the same area in the showerhead stall. Thus, another advantage of this showerhead assembly 1 is that is provide concentrated coverage with an improved spray feel given the opposing trajectories of the spray streams hitting substantially the same target area.

While a preferred showerhead assembly 1 comprising a plurality of hyperboloid spray patterns 37, 47 has been illustrated and described, it would be apparent that various modifications can be made to the showerheads and assembly without departing from the spirit and scope of the invention. Accordingly, it is not intended that the invention be limited except by the following claims. Having described the invention in such terms to enable a person skilled in the art to understand the invention, recreate the invention, and practice it, and having identified the presently preferred embodiments thereof,

I claim:

1. A showerhead comprising:
a housing having a faceplate and a primary conduit configured to receive water from a water source and transport such water to said faceplate;
a set of outer nozzles on said faceplate forming an outer ring, said set of outer nozzles receiving water from said primary conduit and producing a first set of narrow streams of water, said outer nozzles all pointing a same 1-45 degrees in a first direction tangential to said outer ring and said outer nozzles all pointing a same 1-45 degrees radially inward of said outer ring, said first set of narrow streams of water produced by said set of outer nozzles being sufficiently narrow to not intersect substantially with one another so as to produce a first spray pattern having a hyperboloid of revolution shape; and
a set of inner nozzles on said faceplate forming an inner ring which is concentric and radially inward relative to said outer ring, said set of inner nozzles receiving water from said primary conduit and producing a second set of narrow streams of water, said inner nozzles all pointing a same 1-45 degrees in a second direction tangential to said inner ring but opposite to said first direction, and said inner nozzles all pointing a same 1-45 degrees radially inward of said inner ring, said second set of narrow streams of water produced by said set of inner nozzles being sufficiently narrow to not intersect substantially with one another and angled to not intersect with said first set of narrow streams so as to produce a second spray pattern having a hyperboloid of revolution shape.

2. The showerhead of claim 1, wherein said set of inner nozzles comprises a same number of nozzles as said set of outer nozzles.

3. The showerhead of claim 2, wherein said set of inner nozzles further comprises 14 inner nozzles, and wherein said set of outer nozzles further comprises 14 outer nozzles.

4. The showerhead of claim 1, wherein an angle of said first direction is the same as an angle of said second direction.

5. The showerhead of claim 4, wherein said outer nozzles are all pointing about 10-25 degrees in said first direction tangential to said outer ring, and wherein said inner nozzles are all pointing about 10-25 degrees in said second direction tangential to said inner ring.

6. The showerhead of claim 1, wherein said outer nozzles and said inner nozzles are all pointing a same angle radially inward.

7. The showerhead of claim 6, wherein said outer nozzles are all pointing about 12-20 degrees radially inward of said outer ring, and said inner nozzles are all pointing about 12-20 degrees radially inward of said inner ring.

8. The showerhead of claim 1, wherein an angle of said first direction is different than an angle of said outer nozzles pointing radially inward of said outer ring.

9. The showerhead of claim 1, wherein an angle of said second direction is different than an angle of said inner nozzles pointing radially inward of said inner ring.

10. The showerhead of claim 1, wherein said inner nozzles are configured to spray water at a trajectory having an overall tilt of about 15-25 degrees, and wherein said outer nozzles are configured to spray water at a trajectory having an overall tilt of about 15-25 degrees.

11. The showerhead of claim 1, wherein said outer nozzles are concentrically aligned with said inner nozzles.

12. The showerhead of claim 1, where said first spray pattern and said second spray pattern are concentric to one another.

13. The showerhead of claim 1, wherein said second spray pattern is nested within said first spray pattern.

14. The showerhead of claim 1, wherein said first spray pattern is configured to form a first spray matrix, wherein said second spray pattern is configured to form a second spray matrix, and wherein said first spray matrix and said second spray matrix are a same shape.

15. The showerhead of claim 1, wherein said first spray pattern comprises a first smallest cross-sectional area, wherein said second spray pattern comprises a second smallest cross-sectional area, and wherein said first smallest cross-sectional area and said second smallest cross-sectional area are an equal distance away from said faceplate.

16. The showerhead of claim 15, wherein said first smallest cross-sectional area and said second smallest cross-sectional area lie along the same plane.

17. The showerhead of claim 1, wherein each of said outer nozzles is spaced apart equally from each adjacent outer nozzle along said outer ring, and wherein each of said inner nozzles is spaced apart equally from each adjacent inner nozzle along said inner ring.

18. The showerhead of claim 17, wherein each of said outer nozzles is spaced an equal radial distance from a central point of said faceplate, and wherein each of said inner nozzles is spaced an equal radial distance from said central point of said faceplate.

19. The showerhead of claim 1 wherein said inner nozzles are equal in number to aid outer nozzles, said inner nozzle are spaced circumferentially equal to one another, and said outer nozzles are spaced circumferentially equal to one another.

20. The showerhead of claim 1, wherein said inner nozzles and said outer nozzles are configured to spray water contemporaneously.
